(19) United States
(12) Patent Application Publication
(10) Pub. No.: US 2025/0321049 A1
(43) Pub. Date: Oct. 16, 2025

(54) REFRIGERATOR WITH AUTOMATIC LIGHTING AND METHOD TO CONTROL THE AUTOMATIC LIGHTING OF A REFRIGERATOR

(71) Applicant: SMEG S.P.A., GUASTALLA (RE) (IT)

(72) Inventors: Andrea GHIDINI, GUASTALLA (RE) (IT); Mauro LORENZANI, GUASTALLA (RE) (IT); Luca VENTURINI, GUASTALLA (RE) (IT)

(73) Assignee: SMEG S.P.A., GUASTALLA (RE) (IT)

(21) Appl. No.: 19/177,911

(22) Filed: Apr. 14, 2025

(30) Foreign Application Priority Data
Apr. 16, 2024 (IT) 102024000008641

(51) Int. Cl. F25D 27/00; F21V 23/04

(52) U.S. Cl. CPC F25D 27/005; F21V 23/0435

(57) ABSTRACT

A refrigerator comprises:
a main body provided with a cooling chamber;
a door hinged to the main body and movable between a stationary closed position, in which the door closes the cooling chamber, and a fully open position; the door being provided with at least one transparent portion;
a position sensor configured to detect current positions of a reference portion of the door relative to a reference portion of the main body;
a lighting system comprising at least one light source arranged within the chamber;
a control device, configured to activate the at least one light source in response to a command given by a user on the door; the control device being configured to activate the at least one light source when the variation of the current position with respect to a reference position is greater, in absolute value, than an activation threshold.

### CROSS-REFERENCE TO RELATED APPLICATIONS

This patent application claims priority from Italian patent application no. 102024000008641 filed on Apr. 16, 2024, the entire disclosure of which is incorporated herein by reference.

### TECHNICAL FIELD

The present invention concerns a refrigerator with automatic lighting and a method for controlling the automatic lighting of a refrigerator.

The technical reference field of the present invention refers to refrigeration devices, also comprising refrigerated wine display cabinets (i.e. wine coolers, wine fridges).

In particular, the present invention is particularly suitable for refrigerator models having at least one transparent door portion.

### BACKGROUND

As known, refrigeration devices for cooling wine are normally referred to as refrigerated wine display cabinets and are provided with doors which are at least partly transparent.

The transparency of the door, in addition to its aesthetic function, is designed to allow the user to select the bottle with the door closed and, basically, open the door only when the bottle has been selected. In this way the time the door remains open is minimized with evident advantages in terms of maintaining the internal temperature and saving energy.

However, selection of the bottle is facilitated if the lights of the cooled chamber are on.

Refrigerated wine display cabinets are known having a dedicated control for switching on the internal lights. This control is normally arranged on the user interface of the cabinet. However, this solution is not convenient for the user.

The user interface is often positioned near the roof of the cabinet and in large cabinets this position is not always easy to reach. Furthermore, the internal lights are also switched off via the interface, with the result that, given the inconvenience, the internal lights are left on, with evident disadvantages in terms of energy saving and bulb life.

Moreover, the control on the interface is very inconvenient if the refrigerator is provided with an automatic door opening system. In this case, the user has to use two different types of controls depending on whether the automatic door opening command is push-to-open or pull-to-open.

### DESCRIPTION OF THE INVENTION

One object of the present invention is to provide a refrigerator that is free from the drawbacks of the known art highlighted here; in particular, one object of the invention is to provide a refrigerator in which the switch-on control of the internal lights is convenient and easy to operate for the user.

In accordance with said objects the present invention concerns a refrigerator comprising:
a main body provided with a cooling chamber;
a door hinged to the main body and movable between a stationary closed position, in which the door closes the cooling chamber, and a fully open position; the door being provided with at least one transparent portion;
a position sensor configured to detect current positions of a reference portion of the door relative to a reference portion of the main body;
a lighting system comprising at least one light source arranged inside the chamber;
a control device, configured to activate the at least one light source in response to a command given by a user; the control device being configured to activate the at least one light source when the variation of the current position with respect to a reference position is greater, in absolute value, than an activation threshold.

Advantageously, the refrigerator according to the present invention allows activation of the internal light source by touching the door (a simple pull or push action on the door). Moreover, this type of activation of the source integrates easily with any automatic opening system that may already be present in the refrigerator with evident advantages for the user.

A further object of the invention is to provide a method for controlling the automatic lighting of a refrigerator which is simple and intuitive for the user. In accordance with these objects, the present invention concerns a method for controlling the automatic lighting of a refrigerator as claimed in claim 14.

### BRIEF DESCRIPTION OF THE DRAWINGS

Further characteristics and advantages of the present invention will appear clear from the following description of a non-limiting embodiment example thereof, with reference to the figures of the attached drawings, in which:

FIG. 1 is a perspective view of a detail of a refrigerator according to the present invention in a first operating configuration (door closed);

FIG. 2 is a lateral view of the detail of the refrigerator of FIG. 1, with parts removed for clarity;

FIG. 3 is a perspective view of the detail of the refrigerator of FIG. 1 in a second operating configuration (door fully open);

FIG. 4 is a schematic view from above of the detail of FIG. 1 in the first operating configuration (door closed);

FIG. 5 is a schematic view from above of the detail of FIG. 1 in a third operating configuration (door closed-internal lights on);

FIG. 6 is a schematic view from above of the detail of FIG. 1 in a fourth operating configuration (door not fully open);

FIG. 7 is a block diagram which shows schematically the operation of a detail of the refrigerator according to the present invention;

FIG. 8 and FIG. 9 are flow charts that show schematically the operation of further details of the refrigerator according to the present invention.

### DISCLOSURE OF AN EMBODIMENT OF THE INVENTION

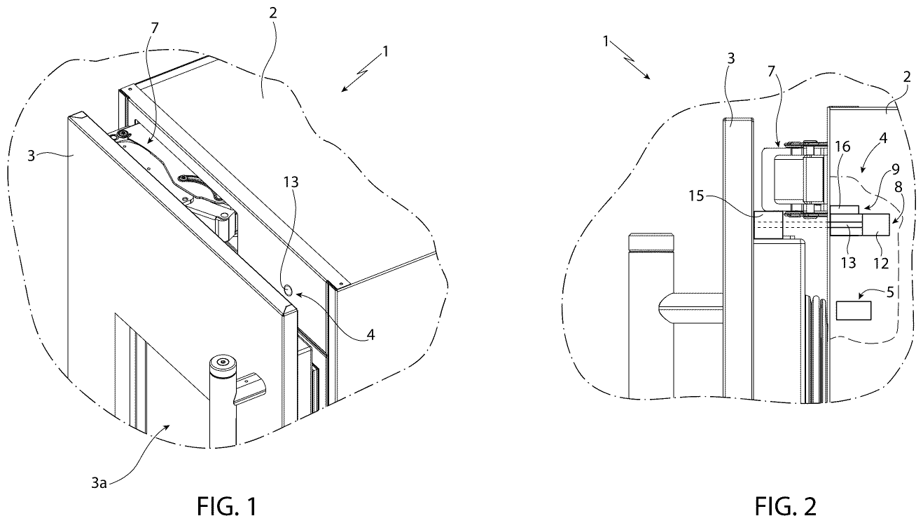

With reference to the attached figures, FIG. 1 shows a portion of a refrigerator 1 according to the present invention. The refrigerator 1 is provided with a main body 2, a door 3 hinged to the main body 2, an automatic opening system 4 configured to open the door 3 on the basis of commands given by a user, and a lighting system 5.

The portion of the refrigerator 1 illustrated and detailed in the following figures is the upper portion of the refrigerator 1 in which the automatic opening system 4 of the door 3 is preferably arranged.

It is understood that the automatic opening system 4 can be housed also in different portions of the refrigerator 1, for example in the lower portion or laterally on the side opposite the side to which the door 3 is hinged.

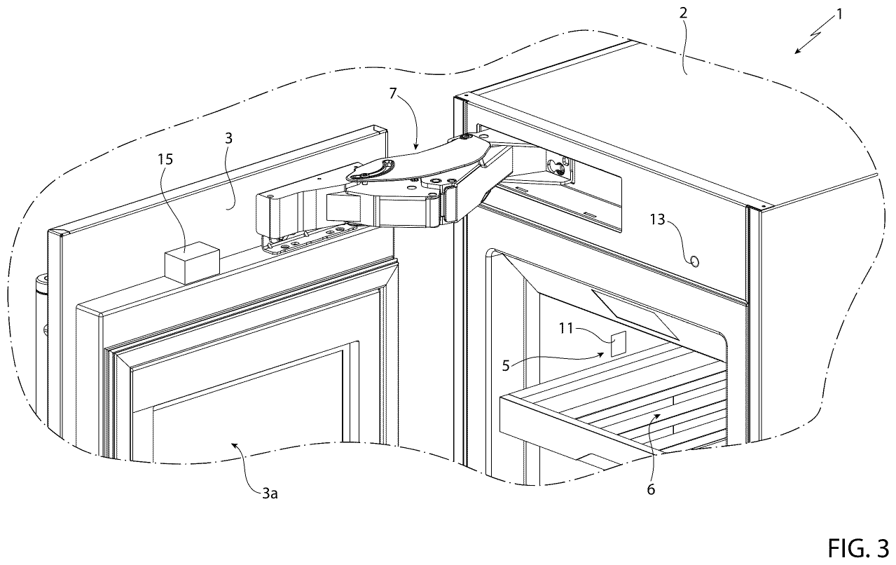

With reference to FIGS. 1, 2 and 3, the main body 2 is provided with a cooling chamber 6 (partly visible in FIG. 3). The cooling chamber 6 is usually provided with a plurality of support elements for housing food and drinks. The refrigerator 1 comprises a cooling system (known and not a subject of the present invention), which is not visible in the attached figures and is configured to cool the cooling chamber 6 in a controlled manner.

The door 3 is hinged to the main body 2 by means of a hinge assembly 7 and can move between a stationary closed position (FIGS. 1, 2, 4 and 5), in which the door 3 closes the chamber 6, and a fully open position (illustrated in FIG. 3) in which the door 3 is arranged at a maximum angular distance from the main body 2.

The door 3 is provided with at least one transparent portion 3a (partly visible in FIGS. 1 and 3) so as to give the user an at least partial view of the cooling chamber 6.

The automatic opening system 4 comprises an opening mechanism 8, at least one position sensor 9 and a control device 10.

The opening mechanism 8 is configured to push the door 3 from the stationary closed position towards the maximum opening position in response to a command CA given by a user on the door 3.

The opening mechanism 8 preferably comprises an actuator 12 and a thrust element 13.

The actuator 12 and the thrust element 13 are preferably housed in the main body 2. In detail, the actuator 12 and the thrust element 13 are housed in a roof portion of the main body 2.

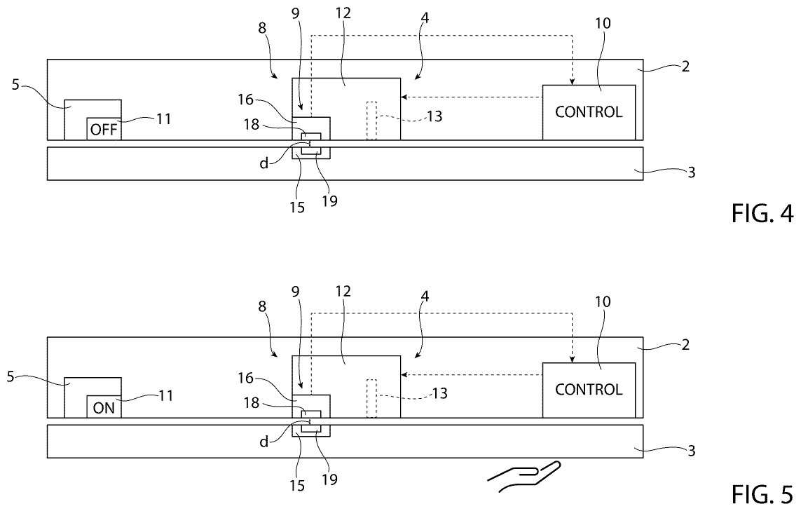

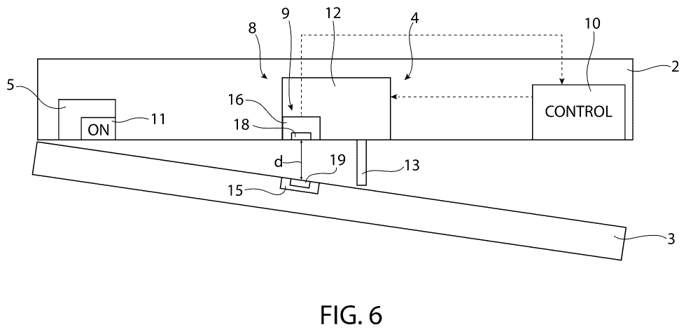

With reference to FIGS. 4 and 6, the actuator 12 is configured to move the thrust element 13 between a rest position (FIG. 4), in which the thrust element 13 is substantially fully housed in the main body 2, and a thrust position (FIG. 6), in which the thrust element 13 protrudes from the main body 2 to exert a thrust on the portion of door 3 facing it.

The actuator 12 is schematically shown in the attached figures and can be made in different ways. For example, the actuator 12 can comprise spring systems or gear movement systems configured to move the thrust element 13 with a force sufficient to determine opening of the door 3. In fact, the thrust provided by the opening mechanism 8 must be sufficient to move the door 3 from the stationary closed position towards the fully open position.

As illustrated in FIG. 6, in the non-limiting example described and illustrated here, the thrust provided by the opening mechanism 8 does not move the door very far away from the stationary position. After the door 3 has been pushed, it is arranged at a distance such as to allow agile movement by the user.

The lighting system 5 comprises at least one light source 11 arranged inside the chamber 6 and configured to light the chamber 6. The light source 11 is schematically shown in FIG. 3 and can have a different shape and position depending on the type of chamber 6 and refrigerator.

The lighting system 5 can obviously comprise other light sources (not illustrated) arranged internally and/or externally to the chamber 6.

The position sensor 9 is configured to detect current positions Pcᵢ of a reference portion 15 of the door 3 relative to a reference portion 16 of the main body 2.

In the non-limiting example described and illustrated here, the position sensor 9 is configured to detect a parameter correlated with the distance d between the reference portion 15 of the door 3 and the reference portion 16 of the main body 2.

The position sensor 9 preferably comprises a Hall device 18 applied to either the reference portion 15 of the door 3 or the reference portion 16 of the main body 2 and a magnet 19 applied to either the reference portion 15 of the door 2 or the reference portion 16 of the main body 2.

In the non-limiting example described and illustrated here, the Hall device 18 is applied to the reference portion 16 of the main body 2, while the magnet 19 is applied to the reference portion 15 of the door 2. In this way, the Hall device 18 can easily communicate with the control device 10 also arranged preferably in the main body 2.

More specifically, the Hall device 18 comprises a Hall effect magnetic field sensor and an electronic board configured to generate a voltage dependent on the magnetic field detected by the Hall effect sensor. The signal generated by the Hall device 18 is therefore a voltage signal. When the door 3 is closed, the voltage signal is maximum because the magnet 19 is very near the Hall device 18. The farther the door 3 moves away, the more the value of the voltage generated by the Hall device 18 decreases.

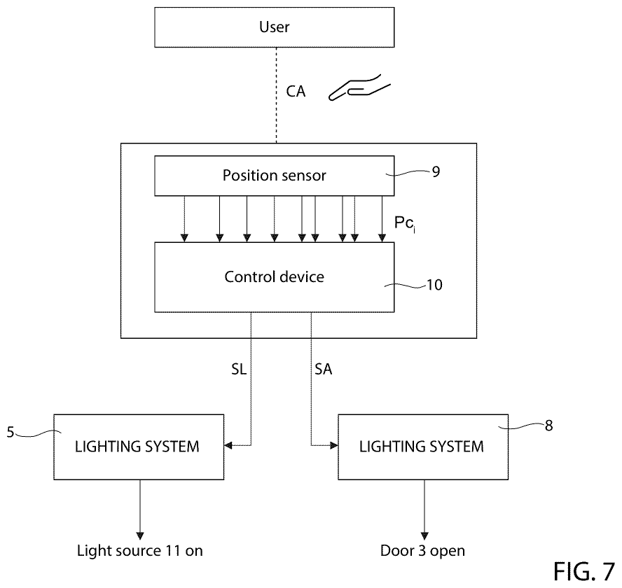

With reference to FIG. 7, the control device 10 is configured to receive the data detected by the position sensor 9 and selectively activate the at least one light source 11 of the lighting system 5 by means of an ignition signal SL.

The same control device 10 is configured to receive the data detected by the position sensor 9 and selectively actuate the opening mechanism 8 on the basis of the incoming data by means of an activation signal SA.

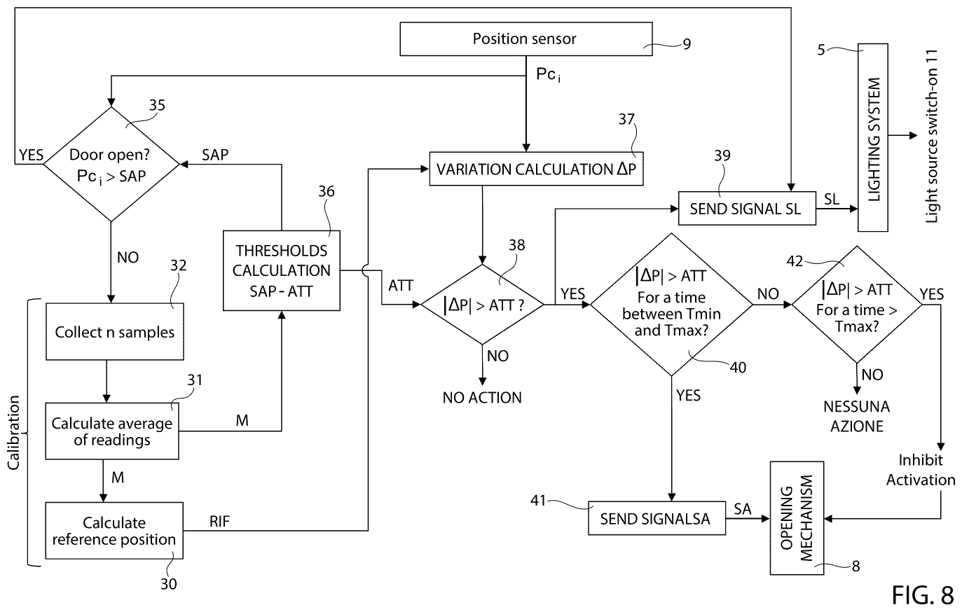

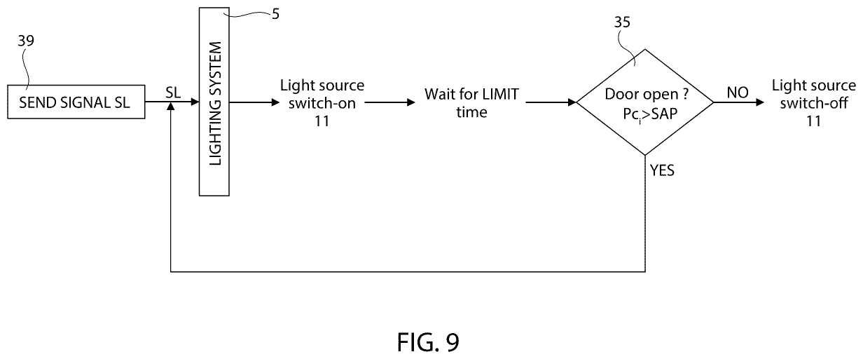

With reference to FIG. 8, the control device 10 is configured to receive the current position data Pcᵢ detected by the position sensor 9 and selectively activate the at least one light source 11 of the lighting system 5 when the variation ΔP of the current position Pcᵢ relative to a reference position RIF is greater, in absolute value, than an activation threshold ATT.

The control device 10 is further configured to actuate the opening mechanism 8 when the variation ΔP of the current position Pcᵢ relative to the reference position RIF is greater, in absolute value, than the activation threshold ATT for an opening time TA comprised between a minimum time Tmin and a maximum time Tmax.

In other words, if the control device 10 detects a variation in the current position data Pcᵢ detected by the position sensor 9 corresponding to a specific command given by the user on the door 3 (push or pull action on the door 3), the light source 11 is immediately activated. If the specific command given by the user (push or pull action on the door 3) persists for a period comprised between a minimum time Tmin and a maximum time Tmax, the control device 10 activates also the opening mechanism 8 of the door 3.

Essentially, at the first touch of the door 3 (push or pull) the user obtains switch-on of the light source 11 and at the second more prolonged touch on the door 3 (push or pull) or by maintaining the first touch on the door 3 for an opening time TA, the user obtains also automatic opening of the door 3.

In particular, the control device 10 is configured to iteratively update the reference position RIF as a function of an average M of the current positions Pcᵢ detected over a time interval when the door 3 is in the stationary closed position (Block 30). In detail, the control device 10 is configured to calculate the average M on a number n of samples detected by the position sensor 9 over a predefined time interval (block 31) and collected by the control device 10 (block 32). The sampling frequency of the samples is settable.

Essentially, the control device 10 is configured to continuously calibrate the reference position RIF on the basis of the readings Pcᵢ collected by the position sensor 9 when the door 3 is in the stationary closed position.

The reference position RIF preferably corresponds to the average M of the n current positions Pcᵢ detected in the time interval. In other words, RIF is preferably equal to M.

To evaluate whether the door 3 is open or closed, the control device 10 preferably verifies the open-door condition (block 35).

To verify the open-door condition, the control device 10 identifies an open-door condition when the current position Pcᵢ exceeds an open-door threshold SAP.

Preferably, the open-door threshold SAP is calculated as a function of the average M (block 36). In other words, SAP=f₁(M). In other words, the open-door threshold SAP is continuously updated on the basis of the average M of the n current positions Pcᵢ detected in the time interval.

Preferably, the door-open threshold SAP is equal to k·M, where k is a predefined coefficient of proportionality.

Therefore, if the door 3 open condition is met, the control device 10 does not perform any operation; if on the other hand the door 3 is closed, the control device 10 proceeds with the calibration step (blocks 30 31 32).

Preferably, also the activation threshold ATT is calculated as a function of the average M (block 36). In other words, ATT=f₂(M).

In other words, the activation threshold ATT is continuously updated on the basis of the average M of the n current positions Pcᵢ detected in the time interval.

Preferably, the activation threshold ATT is defined in the specific example described and illustrated here as proportional to the average of the current positions detected, preferably by a factor 1/n where n is, as specified previously, the number n of samples detected. In other words, ATT=M/n.

Once the threshold ATT has been updated, the control device 10 is configured to compare the module of the detected position variation ΔP with the threshold ATT (module 38).

In other words, the control system 10 is configured to detect whether there has been a distance variation between the door 3 and the main body 2 and calculates said detected position variation ΔP (module 37).

Preferably, the user can give a command CA by means of a push action on the door 3 (push-to-open), which determines a decrease in the position detected (i.e. negative detected position variation ΔP), or the user can give a command CA by means of a pull action on the door 3 (pull-to-open) which determines an increase in the detected position (i.e. positive detected position variation ΔP).

In other words, a positive detected position variation ΔP corresponds to a condition of the door 3 moved away from the main body 2 (pull action—PULL), while a negative detected position variation ΔP corresponds to a condition of the door 3 moved near to the main body 2 (push action—PUSH).

It is understood that the comparisons and the calculations identified above consider the position values deriving from the detections performed by the position sensor 9 and not the value of the signal coming directly from the position sensor 9, which could change according to the type of position sensor 9 used.

For example, in the specific case of the example described here, the position sensor 9 generates a voltage signal that increases as the distance detected between door 3 and main body 2 decreases. Other sensors (for example of optical type) could generate a different signal that increases as the distance detected between door 3 and main body 2 increases.

Usually, the configuration of the command (between PUSH version and PULL version) which the user has to give on the door 3 to activate the lighting system 5 and/or the opening mechanism 8 is predefined prior to supply of the refrigerator 1 or can be changed by the user. However, the control device 10 can operate in both modes, also simultaneously.

In other words, therefore, the control device 10 is configured to activate the light source 11 (by sending the signal SL—module 39) when the user exerts a push action CA on the door 3 such as to determine a negative variation ΔP in the current position and greater, in absolute value, than the activation threshold ATT (module 38); it is also configured to actuate the opening mechanism 8 (by sending the signal SL—module 39) when the user exerts a pull action CA on the door 3 such as to determine a positive variation ΔP in the current position and greater, in absolute value, than the activation threshold ATT (module 38).

In addition to activating the light source 11 when the activation threshold ATT is exceeded, the control device 11 is configured to verify the duration of the command given by the user. If the command given by the user has a duration comprised between a minimum time Tmin and a maximum time Tmax (module 40), the control device 10 activates the opening mechanism 8 (by sending the signal SA—module 41).

If on the other hand the command given by the user has a duration greater than the maximum time Tmax (module 42) the control device 10 inhibits the opening mechanism 8. Said configuration prevents people or things resting on the door 3 of the refrigerator 1 being interpreted as opening commands.

FIG. 8 illustrates a further detail of the control device 10. The control device 10, in fact, is configured to switch off the at least one light source 11 if, after switch-on of the at least one light source 11, an open-door condition is not detected within a time limit.

If an open-door condition is detected, on the other hand, the control device 10 maintains the light source 11 activated. Lastly, it is evident that modifications and variations can be made to the refrigerator and method for controlling the automatic lighting of a refrigerator described and illustrated here without departing from the protective scope of the present invention, as defined in the attached claims.

1. Refrigerator comprising:
a main body (2) provided with a cooling chamber (6);
a door (3) hinged to the main body (2) and movable between a stationary closed position, in which the door (3) closes the cooling chamber (6), and a fully open position; the door (3) being provided with at least one transparent portion (3a);
a position sensor (9) configured to detect current positions (Pcᵢ) of a reference portion (15) of the door (3) relative to a reference portion (16) of the main body (2);
a lighting system (5) comprising at least one light source (11) arranged within the chamber (6);
a control device (10), configured to activate the at least one light source (11) in response to a command (CA) given by a user on the door (3); the control device (10) being configured to activate the at least one light source (11) when the variation of the current position (ΔP) with respect to a reference position (RIF) is greater, in absolute value, than an activation threshold (ATT).

2. Refrigerator according to claim 1, wherein the control device (10) is configured to identify an open-door condition on the basis of the current position (Pcᵢ) detected.

3. Refrigerator according to claim 2, wherein the control device (10) is configured to switch off the at least one light source (11) if, after switching on the at least one light source (11), an open-door condition is not detected within a time limit.

4. Refrigerator according to claim 1, further comprising an opening mechanism (8) configured to push the door (3) from the stationary closed position towards the fully open position in response to an opening command (CA) issued by a user; the control device (10) being configured to actuate the opening mechanism (8) when the variation of the current position (ΔP) with respect to the reference position (RIF) remains higher, in absolute value, than the activation threshold (ATT) for a time comprised between a minimum value (Tmin) and a maximum value (Tmax).

5. Refrigerator according to claim 4, wherein the control device (10) is configured to inhibit the actuation of the opening mechanism (8) if the variation of the current position (ΔP) with respect to the reference position (RIF) remains greater, in absolute value, than the activation threshold (ATT) for a time greater than the maximum value (Tmax).

6. Refrigerator according to claim 1, wherein the control device (10) is configured to iteratively update the reference position (RIF) as a function of an average (M) of the current positions (Pcᵢ) detected over a time interval when the door (3) is in the stationary closed position.

7. Refrigerator according to claim 1, wherein the activation threshold (ATT) is a function of an average (M) of the current positions (Pcᵢ) detected over a time interval when the door (3) is in the stationary closed position.

8. Refrigerator according to claim 6, wherein the activation threshold (ATT) is proportional to the average (M) of the current positions (Pcᵢ) detected.

9. Refrigerator according to claim 6, wherein the average (M) is calculated over a number (n) of samples; the activation threshold (ATT) being proportional to the average (M) of the current positions (Pcᵢ) detected by a factor of 1/n.

10. Refrigerator according to claim 6, wherein the reference position (RIF) is the average (M) of the current detected positions (Pcᵢ).

11. Refrigerator according to claim 1, wherein the control device (10) is configured to activate the at least one light source (11) when the user exerts pressure on the door (3) such that the variation of the current position (ΔP) is negative and exceeds, in absolute value, the activation threshold (ATT).

12. Refrigerator according to claim 1, wherein the control device (10) is configured to activate the at least one light source (11) when the user exerts a pull on the door (3) such that the variation of the current position (ΔP) is positive and greater, in absolute value, than the activation threshold (ATT).

13. Refrigerator according to claim 2, wherein the control device (10) is configured to:
determine an open-door threshold (SAP) as a function of an average (M) of the current positions (Pcᵢ) detected over a time interval when the door (3) is in the stationary closed position;
identify an open-door condition when the current position (Pcᵢ) exceeds the open-door threshold (SAP).

14. Method for controlling the automatic lighting of a refrigerator (1); the refrigerator (1) comprising:
a main body (2) provided with a cooling chamber (6);
a door (3) hinged to the main body (2) and movable between a stationary closed position, in which the door (3) closes the cooling chamber (6), and a fully open position; the door (3) being provided with at least one transparent portion (3a);
a position sensor (9) configured to detect current positions (Pcᵢ) of a reference portion (15) of the door (3) relative to a reference portion (16) of the main body (2);
a lighting system (5) comprising at least one light source (11) arranged within the chamber (6);
the method comprising the step of activating the at least one light source (11) in response to a command (CA) given by a user on the door (3); the step of activating the at least one light source (11) comprising activating the at least one light source (11) when the variation of the current position (ΔP) with respect to a reference position (RIF) is greater, in absolute value, than an activation threshold (ATT).

15. Method according to claim 14, comprising the steps of:
identifying an open-door condition on the basis of the current position (Pcᵢ) detected;
switching-off the at least one light source (11) if, after switching on the at least one light source (11), an open-door condition is not detected within a time limit.
